(19) United States
(12) Patent Application Publication
(10) Pub. No.: US 2008/0225131 A1
(43) Pub. Date: Sep. 18, 2008

(54) Image Analysis System and Image Analysis Method

(75) Inventor: Masaru Aoki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/043,164

(22) Filed: Mar. 6, 2008

(30) Foreign Application Priority Data
Mar. 15, 2007 (JP) 2007-066643

(51) Int. Cl. H04N 5/28

(52) U.S. Cl. 348/222.1; 348/E05.031

(57) ABSTRACT

An image analysis system includes a camera which captures an image of a monitor object, a mirror mounted at a predetermined angle within a visual field of the camera so as to form an image of the monitor object viewed from a direction different from a capturing direction of the camera, and a data processing apparatus which monitors a change in the monitor object by segmenting an image captured by the camera into an image on the mirror and an image except the image on the mirror and separately analyzing the image on the mirror and the image except the image on the mirror. An image analysis method is also disclosed.

This application is based upon and claims the benefit of priority from Japanese patent application No. 2007-066643, filed Mar. 15, 2007, the disclosure of which is incorporated herein in its entirety by reference.

### BACKGROUND OF THE INVENTION

The present invention relates to an image analysis system and image analysis method, which capture an image of a monitor object with a camera and analyze it.

In conventional image analysis, images to be captured are limited depending on camera installation positions, and thus available image information is also limited. For example, at a camera installation position where human faces can be shot, it is difficult to count the number of persons when front and rear faces overlap. It is also difficult to accurately distinguish the floor surface from the tiptoes of feet of a person. This makes it impossible to accurately know the position of the person. In this case, when an image obtained by capturing objects from right above is input, the number of persons can be accurately counted and the position of each person can easily be specified. It is, however, impossible to access features such as human faces and clothes.

To obtain various kinds of information, a plurality of cameras must be stalled depending on an application purpose. The installation of the plurality of cameras increases the product cost and installation expenses.

In order to solve the above problem, there is proposed a technique for capturing images in a plurality of directions by using one camera and mirrors.

For example, reference 1 (Japanese Patent Laid-Open No. 2002-077888) discloses a technique for arranging two plane mirrors at a predetermined angle within the visual field of one camera, allowing the camera to simultaneously capture images reflected in two directions by the two plane mirrors, and simultaneously displaying the captured images in the two directions on a monitor screen.

Reference 2 (Japanese Patent Laid-Open No. 2006-296855) discloses a technique for mounting a mirror at a position where remaining pins of a bowling game are reflected on the mirror from their side surface within the capturing range of one camera, allowing the camera to capture the remaining pins and the mirror, and analyzing the remaining pin image data and the mirror image data, thereby detecting the number of remaining pins.

In the techniques disclosed in references 1 and 2, available information is unfortunately limited. For example, in the technique disclosed in reference 1, only images in the plurality of directions are shot. In the technique disclosed in reference 2, the number of remaining pins in the bowling game can be detected from the images in the plurality of directions. However, the positions of change points (moving object such as a person) of a monitor object and change point passing times cannot be accurately specified.

### SUMMARY OF THE INVENTION

The present invention has been made to solve the conventional problems described above, and has as its object to accurately specify the positions of change points of a monitor object and change point passing times.

According to an aspect of the present invention, there is provided an image analysis system comprising a camera which captures an image of a monitor object, a mirror mounted at a predetermined angle within a visual field of the camera so as to form an image of the monitor object viewed from a direction different from a capturing direction of the camera, and a data processing apparatus which monitors a change in the monitor object by segmenting an image captured by the camera into an image on the mirror and an image except the image on the mirror and separately analyzing the image on the mirror and the image except the image on the mirror.

According another aspect of the present invention, there is provided an image analysis method comprising the steps of capturing an image of a monitor object with a camera in a state in which a mirror is mounted at a predetermined angle within a visual field of the camera so as to form an image of the monitor object viewed from a direction different from a capturing direction of the camera, and monitoring a change in the monitor object by segmenting an image captured by the camera into an image on the mirror and an image except the image on the mirror and separately analyzing the image on the mirror and the image except the image on the mirror.

### BRIEF DESCRIPTION OF THE DRAWINGS

FIG. 1 is a block diagram showing the arrangement of an image analysis system according to the first embodiment of the present invention;

FIG. 2A is a view showing an image captured by a camera according to the first embodiment of the present invention;

FIG. 2B is a plan view showing a region captured by the camera;

FIG. 3 is a block diagram showing the arrangement of a data processing apparatus in the image analysis system according to the first embodiment of the present invention;

FIG. 4 is a flowchart showing the operation of the image analysis system according to the first embodiment of the present invention;

FIG. 5 is a block diagram showing the detailed arrangement of a first analysis unit shown in FIG. 3;

FIG. 6 is a view for explaining the processing for causing the first analysis unit shown in FIG. 5 to map, onto a plan view, the center point of a moving object reflected on a mirror;

FIG. 7 is a flowchart showing the operation of a reference point calculator and a mapping processor in the first analysis unit shown in FIG. 5;

FIG. 8 is a block diagram showing the detailed arrangement of a second analysis unit shown in FIG. 3;

FIG. 9 is a view for explaining the processing for causing the second analysis unit shown in FIG. 8 to map the reference point of the lower end portion of a moving object onto a plan view; and

FIG. 10 is a flowchart showing the operation of a lower end point extractor and a reference point calculator in the second analysis unit shown in FIG. 8.

### DESCRIPTION OF THE PREFERRED EMBODIMENTS

The present invention is characterized in that an image captured by one camera is segmented into a plurality of regions, and the analysis results of the respective regions are mapped to a single image to obtain information as if the image from another direction were analyzed, thereby obtaining a plurality of information without installing a plurality of cameras.

### First Embodiment

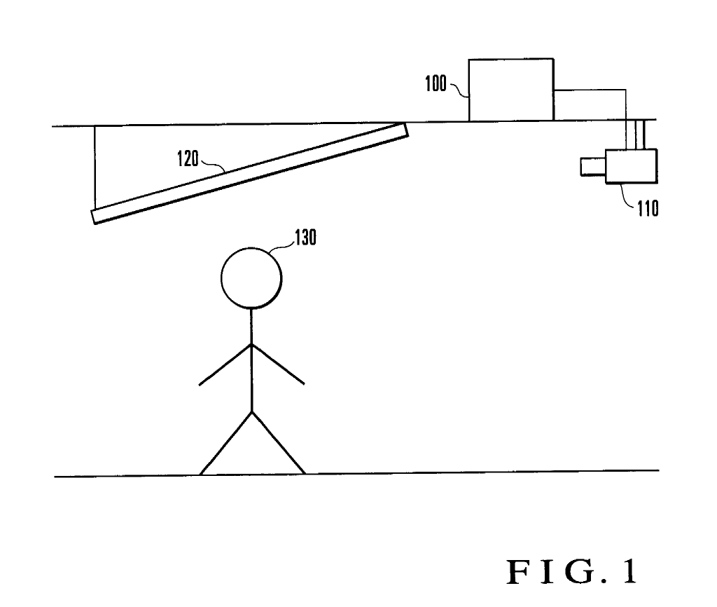

An embodiment of the present invention will be described with reference to the accompanying drawings. FIG. 1 shows the arrangement of an image analysis system according to the first embodiment of the present invention.

The image analysis system according to this embodiment comprises a data processing apparatus 100 including a computer operating by program control, a camera 110 serving as an image acquiring means, and a mirror 120 serving as a light reflecting means.

In order to install the image analysis system of this embodiment in a shop, the mirror 120 is mounted on the ceiling portion at the shop entrance, and the angle of the mirror 120 is adjusted to reflect the head of a customer (monitor object) 130 on it, as shown in FIG. 1.

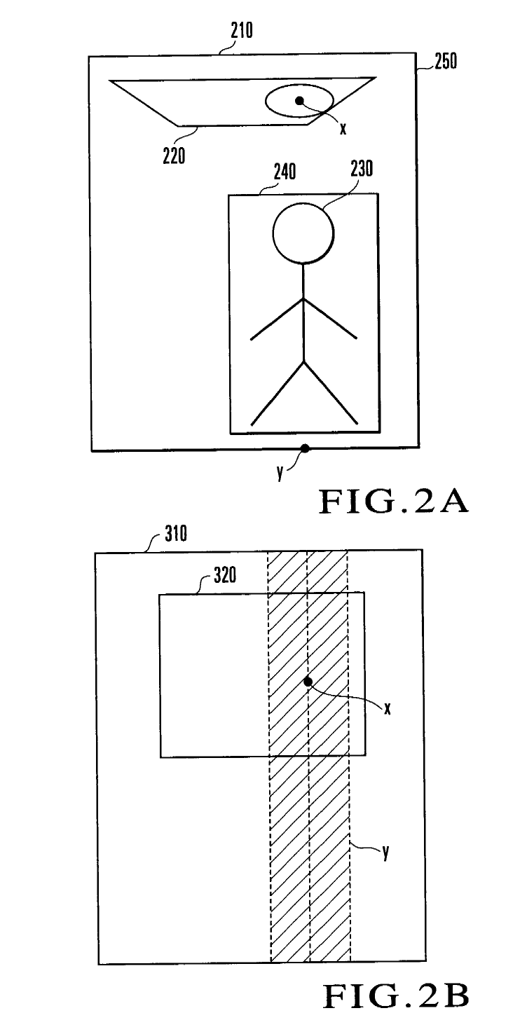

FIG. 2A shows an exemplary image captured by the camera 110. FIG. 2B shows the region captured by the camera 110. Referring to FIG. 2A, reference numeral 210 denotes an image captured by the camera 110; 220, a region of the mirror 120 in the image 210; 230, an image of a customer 130; 240, an image at the shop entrance; and 250, a region of the image 210 except the region 220. Reference symbol x denotes the center point of a moving object (i.e., an image change point, that is, the customer 130 in FIG. 1); and y, a reference point representing the position of the lower end portion of the moving object.

Referring to FIG. 2B, reference numeral 310 denotes a plan view. The plan view 310 represents a region captured by the camera 110 when the camera 110 captures the floor of the shop from right above. Note that the lower side in FIG. 2B corresponds to the deep side (right side in FIG. 1) of the shop.

P(x)=X is defined when the point x in the region 220 of the image 210 captured by the camera 110 is mapped onto a point X in the plan view 310 in FIG. 2B.

In this embodiment, the camera 110 is installed inside the shop at a deeper portion right opposite to the shop entrance. The angle of the camera 110 is adjusted to capture the face and full body of the customer 130 entering the shop and reflect the customer 130 on the mirror 120 mounted on the ceiling portion. At this time, Q(y)=Y is defined when a reference point y indicating the position of feet of the customer 130 standing at the shop entrance is mapped within a reference range Y (i.e., a possible range where the customer 130 stands) in the plan view 310 in FIG. 2B.

According to this embodiment, the position of the customer 130 entering the shop can be specified from an intersection between the point X and the reference range Y.

When customers enter the shop sequentially in an overlapping manner, the heads of the customers sequentially appear in the images on the mirror 120. Since the times at which the heads appear at the position X mapped on the plan view 310 are different from each other in accordance with the images on the mirror 120, the presence of the preceding customer and the presence of the succeeding customer can be recognized. Therefore, the preceding customer can be distinguished from the succeeding customer.

When customers enter the shop side by side, two heads appear laterally in the image on the mirror 120. The plurality of positions X mapped on the plan view 310 from the image on the mirror 120 are present. Even if the reference ranges Y mapped on the plan view 310 from the front image overlap each other, the system can recognize that the two customers have entered the shop and can distinguish them from each other.

Assume that a customer crosses the camera 110. In this case, if no image is present in the region 220 of the mirror 120, the customer who has crossed the camera 110 can be distinguished from a customer who has passed through the entrance. This also applies to customers present outside the shop. This makes it possible to accurately count the number of customers entering the shop.

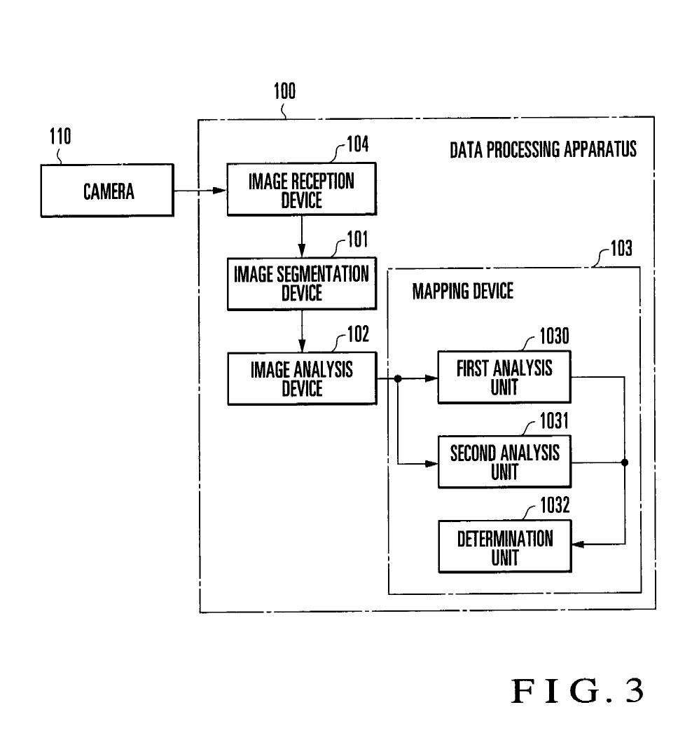

FIG. 3 shows the arrangement of the data processing apparatus 100. The data processing apparatus 100 comprises an image segmentation device 101 which segments an image into a plurality of regions, an image analysis device 102 which analyzes an image, a mapping device 103 which maps a given point on an image onto the plan view 310, and an image reception device 104 which receives an image captured by the camera 110.

The mapping device 103 comprises a first analysis unit 1030 which analyzes an image of the region 220 of the mirror 120 in the image captured by the camera 110, a second analysis unit 1031 which analyzes the image of the region 250 captured by the camera 110 except the image of the region 220, and a determination unit 1032 which executes predetermined determination for the images analyzed by the first and second analysis units 1030 and 1031.

The constituent elements of the data processing apparatus 100 roughly operate as follows. First of all, the image reception device 104 receives image information captured by the camera 110.

The image segmentation device 101 segments the region of an image input from the image reception device 104 into a specific region and a region except the specific region and allows to process the specific region as another image. More specifically, the image segmentation device 101 segments the image into the region 220 of the mirror 120 and the region 250 except the region 220.

The image analysis device 102 extracts a change point in an image and traces a moving object within this image.

The mapping device 103 maps, on the plan view 310, the center point x of the moving object in the image 210 captured by the camera 110. The mapping device 103 then determines whether the center point x of the moving object corresponds to the specific reference range Y or a specific reference line on the plan view 310.

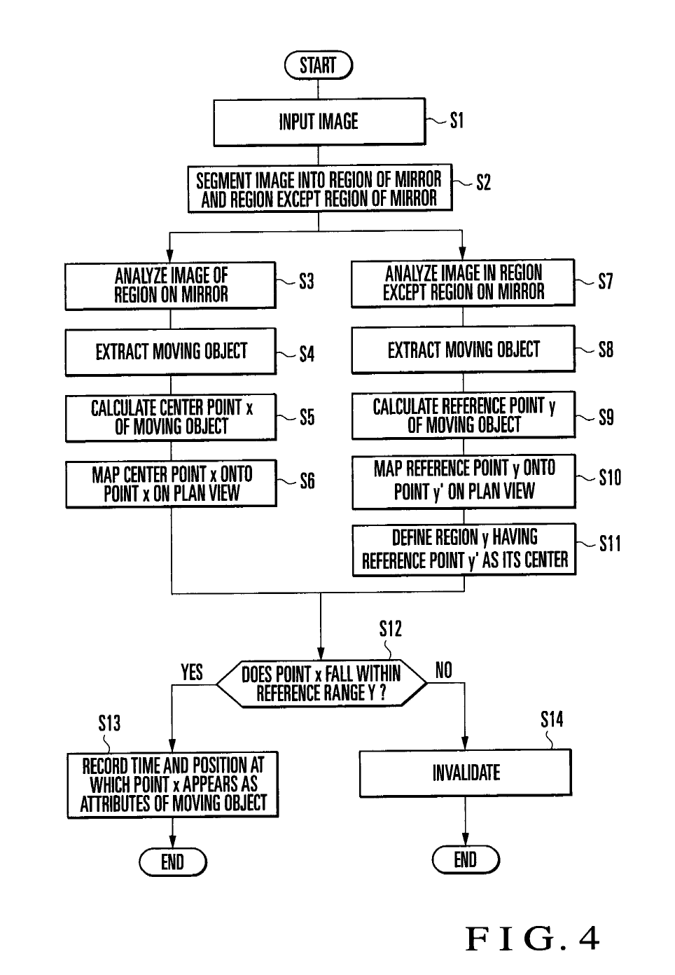

The operation of this embodiment will be described in detail with reference to the flowchart in FIG. 4. An image from the camera 110 is input to the data processing apparatus 100 (step S1). The reception device 104 in the data processing apparatus 100 receives image information input from the camera 110.

The image segmentation device 101 segments the input image into the predefined region 220 of the mirror 120 and the region 250 except the region 220 (step S2).

The image analysis device 102 analyzes the image of the region 220 segmented by the image segmentation device 101 (step S3) and extracts the moving object from the image of the region 220 (step S4). The moving image extraction is done by, e.g., checking a change between a plurality of image frames and detecting a change portion of the image as a moving object.

The first analysis unit 1030 of the mapping device 103 generates data obtained by mapping the center point of the moving object in the region 220 onto the plan view 310.

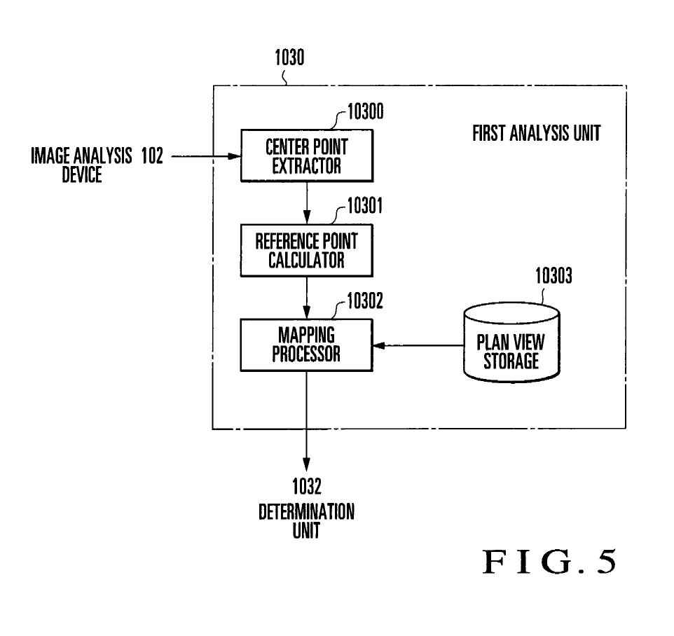

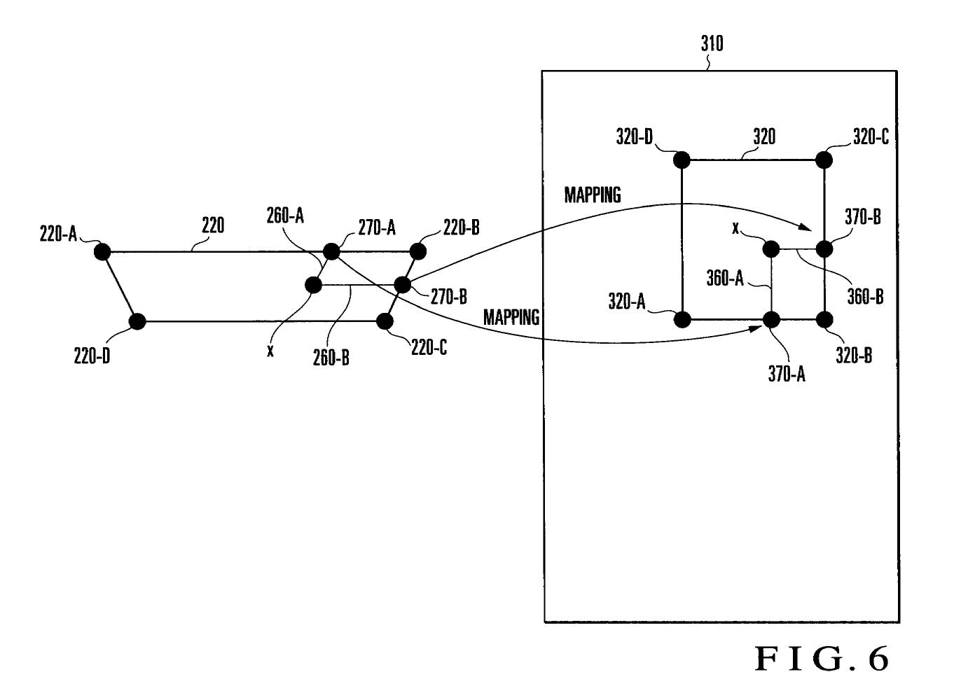

FIG. 5 shows the detailed arrangement of the first analysis unit 1030. FIG. 6 explains processing for causing the first analysis unit 1030 to map, onto the plan view 310, the center point of the moving image on the mirror. The first analysis unit 1030 comprises a center point extractor 10300, a first reference point calculator 10301, a first mapping processor 10302, and a plan view storage 10303.

Referring to FIG. 6, reference numerals 220-A, 220-B, 220-C, and 220-D denote vertices of the region 220; 260-A, a straight line passing through the center point x of the moving object and parallel to a side connecting the vertices 220-B and 220-C of the region 220; 260-B, a straight line passing through the center point x of the moving object and parallel to a side connecting the vertices 220-A and 220-B of the region 220; 270-A, a reference point as the intersection between the straight line 260-A and the side connecting the vertices 220-A and 220-B; and 270-B, a reference point as the intersection between the straight line 260-B and the side connecting the vertices 220-B and 220-C. Reference numeral 320 denotes a region obtained upon mapping the region 220 onto the plan view 310. Reference numerals 320-A, 320-B, 320-C, and 320-D denote points obtained upon mapping the vertices 220-A, 220-B, 220-C, and 220-D onto the plan view 310; 360-A and 360-B, straight lines obtained upon mapping the straight lines 260-A and 260-H onto the plan view 310; and 370-A and 370-B, points obtained upon mapping the reference points 270-A and 270-B onto the plan view 310. Reference symbol X denotes a point obtained upon mapping the center point x of the moving object onto the plan view 310.

The center point extractor 10300 of the first analysis unit 1030 calculates the position of the center point x of the moving object in accordance with the moving object image extracted by the image analysis device 102 in step S4 (step S5).

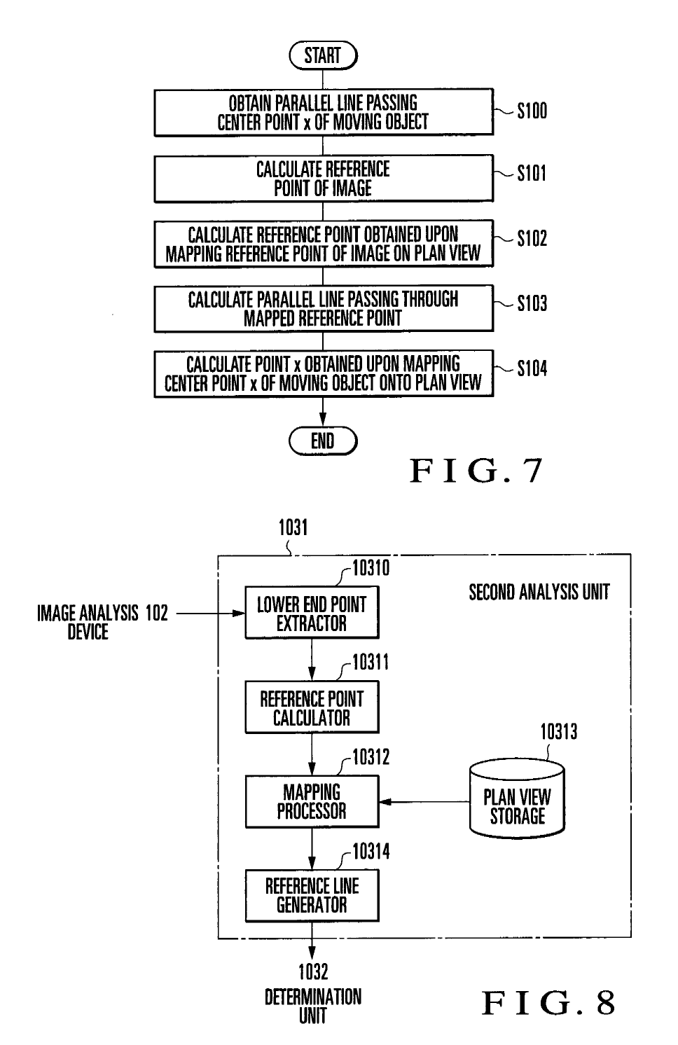

Subsequently, the reference point calculator 10301 and mapping processor 10302 in the first analysis unit 1030 maps the center point x of the moving object onto the plan view 310 in accordance with a predefined formula, thereby calculating the position of the point X (step S6). FIG. 7 shows the operation of the reference point calculator 10301 and mapping processor 10302.

The reference point calculator 10301 calculates the straight line 260-A passing through the center point x of the moving object and parallel to the side connecting the vertices 220-B and 220-C of the region 220 on the image of the region 220 shown in FIG. 6 (step S100). At the same time, the reference point calculator 10301 calculates the straight line 260-B passing through the center point x of the moving object and parallel to the side connecting the vertices 220-A and 220-B on the image of the region 220 (step S100). The positions of the vertices 220-A, 220-B, 220-C, and 220-D of the region 220 are known in advance. Therefore, when the position of the center point x of the moving object is determined, the reference point calculator 10301 can calculate the straight lines 260-A and 260-B.

The reference point calculator 10301 calculates the position of the reference point 270-A as the intersection between the straight line 260-A and the side connecting the vertices 220-A and 220-B and the position of the reference point 270-B as the intersection between the straight line 260-B and the side connecting the vertices 220-B and 220-C (step 101).

Note that the straight line 260-A is a line parallel to at least one of two opposing outer sides of the region 220, i.e., the side connecting the vertices 220-A and 220-B and the side connecting the vertices 220-C and 220-D. Similarly, the straight line 260-B is a line parallel to at least one of two outer sides crossing the above two opposing outer sides, i.e., the side connecting the vertices 220-B and 220-C and the side connecting the vertices 220-A and 220-D. The straight line 260-A may be drawn toward the side connecting the vertices 220-B and 220-C, and the straight line 260-B may be drawn toward the side connecting the vertices 220-A and 220-D.

The mapping processor 10302 maps the reference points 260-A and 260-B calculated by the reference point calculator 10301 onto the plan view 310 to obtain the reference points 370-A and 370-B (step S102). The plan view 310 is stored in the plan view storage 10303 in advance. The positions of the points 320-A, 320-B, 320-C, and 320-D obtained upon mapping the vertices 220-A, 220-B, 220-C, and 220-D onto the plan view 310 are known in advance.

Letting L1 be the length of the side connecting the vertices 220-A and 220-B of the region 220, D1 be the distance from the vertex 220-A to the reference point 270-A, L2 be the length of the side connecting the vertices 320-A and 320-B of the region 320, and D2 be the distance from the vertex 320-A to the reference point 370-A, the following relation holds:

D1/L1=D2/L2 (1)

A point which satisfies relation (1) obtained on the side connecting the vertices 320-A and 320-B of the region 320 is defined as the reference point 370-A.

Similarly, letting L3 be the length of the side connecting the vertices 220-B and 220-C of the region 220, D3 be the distance from the vertex 220-B to the reference point 270-B, L4 be the length of the side connecting the vertices 320-B and 320-C of the region 320, and D4 be the distance from the vertex 320-B to the reference point 370-B, the following region holds:

D3/L3=D4/L4 (2)

A point which satisfies relation (2) on the side connecting the vertices 320-B and 320-C of the region 320 is defined as the reference point 370-B.

The mapping processor 10302 calculates the straight line 360-A passing through the reference point 370-A and parallel to the side connecting the vertices 320-B and 320-C of the region 320 and the straight line 360-B passing through the reference point 370-B and parallel to the side connecting the vertices 320-A and 320-B of the region 320 (step S103).

Finally, the mapping processor 10302 defines the intersection between the straight lines 360-A and 360-B as the point X obtained upon mapping the center point x of the moving object onto the plan view 310, thereby calculating the position of the reference point X (step S104). The mapping processor 10302 notifies the determination unit 1032 of the position of the reference point X. The processing in step S6 in FIG. 4 has thus completed to end the processing of the first analysis unit 1030.

The image analysis device 102 analyzes the image of the region 250 segmented by the image segmentation device 101 (step S7 in FIG. 4) and extracts the moving object from the image of the region 250 (step S8). This moving object extraction is done as in the region 220.

The second analysis unit 1031 of the mapping device 103 generates data obtained by mapping the reference point including the center point of the lower end portion of the moving object in the region 250 on the plan view 310.

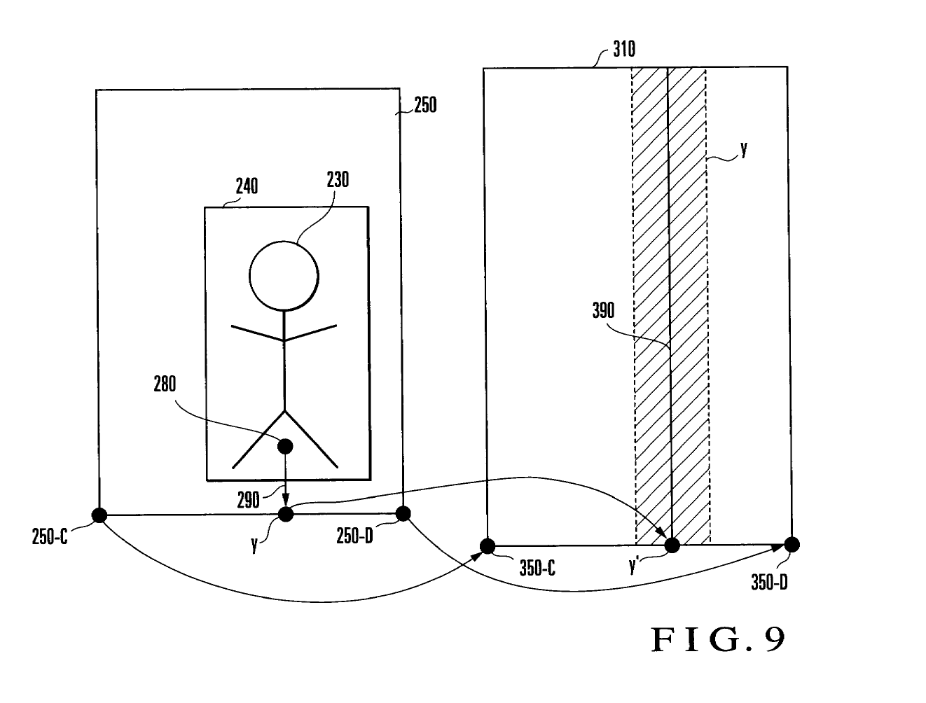

FIG. 8 shows the detailed arrangement of the second analysis unit 1031. FIG. 9 explains processing for causing the second analysis unit 1031 to map the reference point of the lower end portion of the moving object onto the plan view 310. The second analysis unit 1031 comprises a lower end point extractor 10310, a second reference point calculator 10311, a second mapping processor 10312, a plan view storage 10313, and a reference line generator 10314.

Referring to FIG. 9, reference numerals 250-C and 250-D denote vertices of the region 250; 280, the center point of the lower end portion of the moving object; and 290, a straight line passing through the center point 290 of the lower end portion of the moving object and perpendicular to a side connecting the vertices 250-C and 250-D of the region 250. Reference numeral y denotes a reference point as an intersection between the straight line 290 and the side connected to the vertices 250-C and 250-D. Reference numerals 350-C and 350-D denote points obtained upon mapping the vertices 250-C and 250-D onto the plan view 310. Reference symbol y′ denote a point obtained upon mapping the reference point y onto the plan view 310. Reference numeral 390 denotes a line passing through the reference point y′ and perpendicular to the side connecting the vertices 350-C and 350-D.

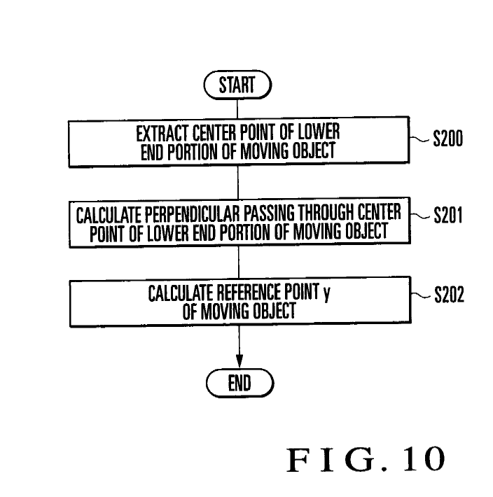

The lower end point extractor 10310 and reference point calculator 10311 of the second analysis unit 1031 calculate the position of the reference point y of the moving object from the moving object image extracted by the image analysis unit 102 in step S8 (step S9). FIG. 10 shows the operation of the lower end point extractor 10310 and reference point calculator 10311.

The lower end point extractor 10310 recognizes the center point 280 of the lower end portion (e.g., the foot portion of the image 230 of the customer, as shown in FIG. 9) of the moving object in accordance with image analysis, thereby extracting the center point 280 (step S200).

The reference point calculator 10311 calculates the straight line (perpendicular) 290 passing through the center point 280 of the lower end portion of the moving object and perpendicular to the side (outer side) connecting the vertices 250-C and 250-D of the region 250 (step S201). The positions of the vertices 250-C and 250-D (i.e., the vertices of the lower end of the image captured by the camera 110) are known in advance. When the position of the center point 280 of the lower end portion of the moving object is determined, the straight line 290 can be obtained.

The reference point calculator 10311 calculates the position of the reference point y using as the reference point y the intersection between the straight line 290 and the side connecting the vertices 250-C and 250-D (step S202). Processing in step S9 of FIG. 4 has completed.

The mapping processor 10312 maps on the plan view 310 the reference point y calculated by the reference point calculator 10311 in accordance with the predefined calculation formula, thereby obtaining the reference point y (step S10 in FIG. 4). The plan view 310 is stored in the plan view storage 10313 in advance, and the positions of the points 350-C and 350-D upon mapping the vertices 250-C and 250-D on the plan view 310 are known in advance.

Letting L5 be the length of the side connecting the vertices 250-C and 250-D of the region 250, D5 be the distance from the vertex 250-C to the reference point y, L6 be the length of the side connecting the vertices 350-C and 350-D of the plan view 310, and D6 be the distance from the vertex 350-C to the reference point y′, the following relation holds:

D5/L5=D6/L6 (3)

A point which satisfies relation (3) on the side connecting the vertices 350-C and 350-D of the plan view 310 is defined as the reference point y′.

The reference line generator 10314 calculates a line (reference line) 390 passing through the reference point y′ and perpendicular to a side (outer side) connecting the vertices 350-C and 350-D of the plan view 310. The reference line generator 10314 then defines, as the reference range Y, a range extending in the right and left directions from the reference line 390 by a predetermined distance (step S11). The reference line generator 10314 notifies the determination unit 1032 of the positions of the reference line 390 and the reference range Y. Processing of the second analysis unit 1031 has completed.

The determination unit 1032 compares the position of the reference point X notified from the first analysis unit 1030 with the position of the reference range Y notified from the second analysis unit 1031 and determines whether the reference point X falls within the reference range Y (step S12).

When the reference point X falls within the reference range Y, the determination unit 1032 associates the time at which the center point x of the moving object appears in step S5, the position of the reference point X calculated in step S6, and the moving object image extracted in step S8 with each other. The determination unit 1032 records the time and position as the attributes of the moving object (step S13).

When the reference point X does not fall within the reference range 1032, the determination unit 1032 invalidates the processing results in steps S2 to S6 and S7 to S11 (step S14).

The position of the reference point X may be compared with the position of the reference line 390 in step S12 in place of the comparison between the position of the reference point X and the position of the reference range Y. In this case, when the reference point X crosses the reference line 390, the determination unit 1032 determines YES. The process then advances to step S13.

The effects of this embodiment will be described below. In this embodiment, since the image of the moving object from right above it can be input by the mirror 120, the moving object can be separated. This makes it possible to accurately count the number of moving objects passing through the capturing region of the camera 110. According to this embodiment, the image on the image on the mirror 120 is mapped onto the plan view. This makes it possible to grasp the position of the moving object from the image from the front of the camera, thereby accurately grasping the position of the moving object.

According to this embodiment, the camera 110 allows the user to access the front image of the moving object such as a person and the image right above the moving object on the mirror 120. This makes it possible to reduce the number of installed cameras 110. According to this embodiment, the image from the front of the camera except the image on the mirror 120 and the image on the mirror 120 can be separately analyzed. The number of pieces of information is larger than that obtained when only the images from the front of the camera are analyzed.

According to this embodiment, the analysis result of the image from the front of the camera except the image on the mirror 120 and the analysis result of the image on the mirror 120 are mapped on the same plan view 310. It is possible to determine whether a moving object present in the image from the front of the camera except the image on the mirror 120 and a moving object present in the image on the mirror 120 are identical.

### Second Embodiment

The second embodiment of the present invention will be explained below. To monitor facilities such as piping, the image on the lower side of the piping is not present in the image from the front side of the camera. This makes it impossible to detect changes such as cracks or corrosion. To solve this problem, using the arrangement of the first embodiment, a mirror 120 is placed on the lower wall surface side of the piping, and an image on the lower wall surface side is captured. The image from the front side of the camera except the image on the mirror 120 is analyzed separately from the image on the mirror 120. The analysis results are mapped onto a piping simulation model, thereby allowing the user to monitor changes in piping as a whole.

During tracing a person indoors, a blind spot may be formed in an image of one camera by a pillar or cabinet. In order to solve this problem, the arrangement of the first embodiment is used to install a mirror 120 on a wall surface so as to capture a scene behind the pillar or cabinet. When the moving object enters a blind spot, the image on the mirror 120 is analyzed to allow the user to trace the moving object. The time and place at which the moving object appears again in the image area for the front side of the camera from the blind spot can be determined. The moving object captured before it enters the blind spot and the moving object captured after it appears again can be traced as the same moving object.

When the moving object advances straight toward the camera 110, the time and position at which the moving object appears on the mirror 120 can be accurately grasped by installing mirrors 120 at a plurality of ceiling portions. It is therefore possible to determine the accurate position of the moving object coming close to the camera.

The data processing apparatus 100 of each of the first and second embodiments can be implemented by a computer having, e.g., a CPU, a memory, and an interface, and programs for controlling these hardware resources. The programs running on the computer can be provided while being recorded on a computer-readable recording medium such as a flexible disk, CD-ROM, DVD-ROM, or memory card. The CPU writes the loaded programs in the memory unit and executes the processing described in the first and second embodiments in accordance with the programs.

In each embodiment described above, there are provided a camera for capturing an image of a monitor object and a mirror mounted at a predetermined angle within the visual field of the camera so as to form the image of the monitor object viewed from a direction different from the capturing direction of the camera. The image captured by the camera is segmented into the image on the mirror and images other than the image on the mirror. These segmented images are separately analyzed. This makes it possible to monitor the changes in the monitor object from two different directions using one camera and improve the recognition and tracing precision of the change in monitor object.

According to each embodiment described above, the number of pieces of available information increases. This is because an image from another direction can be obtained by the mirror and then analyzed to obtain new information. For example, information indicating the number of persons and information indicating the faces of the persons can be obtained.

According to each embodiment described above, the position of the change point of the monitor object can be accurately specified. This is because the image from another direction is obtained by the mirror and then analyzed. This facilitates to distinguish a given change point from another change point.

According to each embodiment described above, the time at which a change point passes can be accurately specified. This is because the image from another direction is obtained by the mirror and then analyzed to specify the time at which the moving object has entered the visual range of the mirror.

The present invention is applicable to commercial facilities such as shops to grasp the sex, faces, and clothes of customers while grasping the number of customers. In addition, in an office or plant, the present invention is also applicable to a purpose of grasping a specific person passing a specific place at a specific time. In a building or plant, the present invention is further applicable to a purpose of efficiently performing management operations such as early facility aging detection and abnormality detection.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An image analysis system comprising:
a camera which captures an image of a monitor object;
a mirror mounted at a predetermined angle within a visual field of said camera so as to form an image of the monitor object viewed from a direction different from a capturing direction of said camera; and
a data processing apparatus which monitors a change in the monitor object by segmenting an image captured by said camera into an image on said mirror and an image except the image on said mirror and separately analyzing the image on said mirror and the image except the image on said mirror.

2. A system to claim 1, wherein said data processing apparatus comprises:
an image segmentation device which segments the image captured by said camera into the image on said mirror and the image except the image on said mirror;
an image analysis device which detects a change point in each of the image on said mirror and the image except the image on said mirror; and
a mapping device which maps an analysis result of the change point in the image on said mirror and an analysis result of the change point in the image except the image on said mirror onto a plan view and monitors the change of the monitor object.

3. A system according to claim 2, wherein said mapping device comprises:
a first analysis unit which analyzes the change point in the image on said mirror;
a second analysis unit which analyzes the change point in the image except the image on said mirror; and
a determination unit which detects a position and time of the change of the monitor object and the number of changes by mapping an analysis result of the change point in the image on said mirror and an analysis result of the change point in the image except the image on said mirror onto a plan view.

4. A system according to claim 3, wherein
said first analysis unit comprises
a center point extractor which calculates a position of the center of the change point in the image on said mirror,
a first reference point calculator which calculates two parallel lines passing through the center of the change point and parallel to two outer sides, respectively, crossing the image on said mirror and calculates two reference points as intersections between the two parallel lines and two outer sides, and
a first mapping processor which maps the two reference points calculated by said first reference point calculator onto the plan view of the monitor object, calculates, based on the two mapped reference points, a position of a point obtained upon mapping the center of the change point in the image on said mirror onto the plan view, and outputs the position of the mapped point as an analysis result to said determination unit; and
said second analysis unit comprises
a lower end point extractor which calculates a position of the center of a lower end portion of the change point in the image except the image on said mirror,
a second reference point calculator which calculates a perpendicular passing through the center of the lower end portion of the change point and perpendicular to one outer side of the image except the image on said mirror and calculates a reference point as an intersection between the perpendicular and said one outer side,
a second mapping processor which maps the reference point calculated by said second reference point calculator onto the plan view of the monitor object, and
a reference line generator which defines, as a reference line, a line passing through the reference point mapped by said second mapping processor and perpendicular to one outer side of a region in which the image except the image on said mirror is mapped on the plan view of the monitor object, and outputs, as analysis results, the position of the reference line and the position of a reference range extending from the reference line by a predetermined distance to said determination unit.

5. A system according to claim 4, wherein when the position of the point output as the analysis result from said first analysis unit falls within the reference range output as the analysis result from said second analysis unit, said determination unit associates a time at which the center of the change point in the image on said mirror appears, a position of the point calculated by said first mapping processor, and the image of the change point in the image except the image on said mirror with each other, and records the time and position as attributes of the change point.

6. A system according to claim 4, wherein when the position of the point output as the analysis result from said first analysis unit crosses the position of the reference line output as the analysis result from said second analysis unit, said determination unit associates a time at which the center of the change point in the image on said mirror appears, a position of the point calculated by said first mapping processor, and the image of the change point in the image except the image on said mirror with each other, and records the time and position as attributes of the change point.

7. An image analysis method comprising the steps of:
capturing an image of a monitor object with a camera in a state in which a mirror is mounted at a predetermined angle within a visual field of the camera so as to form an image of the monitor object viewed from a direction different from a capturing direction of the camera; and
monitoring a change in the monitor object by segmenting an image captured by the camera into an image on the mirror and an image except the image on the mirror and separately analyzing the image on the mirror and the image except the image on the mirror.

8. A method to claim 7, wherein the step of monitoring comprises the steps of:
segmenting the image captured by the camera into the image on the mirror and the image except the image on the mirror;
detecting a change point in each of the image on the mirror and the image except the image on the mirror; and
mapping an analysis result of the change point in the image on the mirror and an analysis result of the change point in the image except the image on the mirror onto a plan view and monitors the change of the monitor object.

9. A method according to claim 8, wherein the step of mapping comprises the steps of:
analyzing the change point in the image on the mirror;
analyzing the change point in the image except the image on the mirror; and
detecting a position and time of the change in the monitor object and the number of changes by mapping an analysis result of the change point in the image on the mirror and an analysis result of the change point in the image except the image on the mirror onto a plan view.

10. A method according to claim 9, wherein
the step of analyzing the change point in the image on the mirror comprises the steps of
calculating a position of the center of the change point in the image on the mirror,
calculating two parallel lines passing through the center of the change point and parallel to two outer sides, respectively, crossing the image on the mirror and calculating two reference points as intersections between the two parallel lines and two outer sides, and
mapping the two calculated reference points onto the plan view of the monitor object, calculating, based on the two mapped reference points, a position of a point obtained upon mapping the center of the change point in the image on the mirror onto the plan view, and outputting the position of the mapped point as an analysis result; and
the step of analyzing the change point in the image except the image on the mirror comprises the steps of
calculating a position of the center of a lower end portion of the change point in the image except the image on the mirror,
calculating a perpendicular passing through the center of the lower end portion of the change point and perpendicular to one outer side of the image except the image on the mirror and calculating a reference point as an intersection between the perpendicular and the one outer side,
mapping the calculated reference point onto the plan view of the monitor object, and
defining, as a reference line, a line passing through the mapped reference point and perpendicular to one outer side of a region in which the image except the image on the mirror is mapped on the plan view of the monitor object, and outputting, as analysis results, the position of the reference line and the position of a reference range extending from the reference line by a predetermined distance.

11. A method according to claim 10, wherein when the position of the point output as the analysis result falls within the reference range output as the analysis result, the step of detecting a position and time of the change comprises the step of associating a time at which the center of the change point in the image on the mirror appears, a position of the point, and the image of the change point in the image except the image on the mirror with each other, and recording the time and position as attributes of the change point.

12. A method according to claim 10, wherein when the position of the point output as the analysis result crosses the position of the reference line output as the analysis result, the step of detecting a position and time of the change comprises the step of associating a time at which the center of the change point in the image on the mirror appears, a position of the point, and the image of the change point in the image except the image on the mirror with each other, and recording the time and position as attributes of the change point.

13. A computer-readable recording medium which records a program to cause a computer to execute the step of segmenting an image of a monitor object captured with a camera, in a state in which a mirror is mounted at a predetermined angle within a visual field of the camera so as to form an image of the monitor object viewed from a direction different from a capturing direction of the camera, into an image captured by the camera into an image on the mirror and an image except the image on the mirror and separately analyzing the image on the mirror and the image except the image on the mirror, thereby monitoring the change of the monitor object.
